(19) United States
(12) Patent Application Publication
(10) Pub. No.: US 2014/0220080 A1
(43) Pub. Date: Aug. 7, 2014

(54) IgA SECRETION PROMOTER

(71) Applicants: MATSUTANI CHEMICAL INDUSTRY CO., LTD., Itami-shi (JP); NIHON UNIVERSITY, Tokyo (JP)

(72) Inventors: Shoko MIYAZATO, Itami-shi (JP); Yuka KISHIMOTO, Sanda-shi (JP); Akira HOSONO, Tokyo (JP); Kyoko TAKAHASHI, Yamato-shi (JP); Shuichi KAMINOGAWA, Tokyo (JP)

(21) Appl. No.: 13/871,517

(22) Filed: Apr. 26, 2013

(30) Foreign Application Priority Data
Feb. 6, 2013 (JP) 2013-021411

(51) Int. Cl. C08B 30/18

(52) U.S. Cl. CPC C08B 30/18
USPC 424/278.1; 536/103

(57) ABSTRACT

Provided is a novel IgA secretion promoter useful as a mucosal immunity stimulation agent and a method of promoting IgA secretion in a body of animal to stimulate mucosal immunity. A significant action of promoting IgA secretion was observed in oral administration of indigestible dextrin.

### TECHNICAL FIELD

The present invention relates to an IgA secretion promoter comprising indigestible dextrin as an active ingredient or a method of promoting IgA secretion in an animal.

### BACKGROUND ART

The gastrointestinal tract is always in contact with microorganisms such as bacteria and viruses and many substances such as pathogenic antigens and food antigens. In the intestinal tract, strong functions of the mucosal immunity are developed to prevent these exogenous antigens from entering the living organism. Especially, IgA secreted from Peyer's patches, which are a representative lymphatic tissue in the intestinal tract, plays important roles in functions of the mucosal immunity, because IgA has actions such as prevention of attachment of bacteria and viruses onto mucosal surfaces, foreign substance removal in which exogenous antigens are trapped and discharged to the outside of the body, and prevention of development of allergy due to foreign proteins. For this reason, it can be expected that promotion of IgA secretion brings effects such as reinforcement of functions of the mucosal immunity and prevention of infectious diseases and allergic diseases. Hence, development of a food ingredient having an action of promoting IgA secretion has been desired.

Recent reports showed that indigestible and low-molecular weight oligosaccharides such as fructooligosaccharide (Patent Literature 1), galactooligosaccharide (Non-Patent Literature 1), isomaltooligosaccharide (Non-Patent Literature 2), lactosucrose (Non-Patent Literature 3), and cycloinulooligosaccharide (Patent Literature 2) have an action of promoting IgA secretion. Although several kinds of oligosaccharides exist, the oligosaccharides are common in terms of intestinal environment improvement functions such as a function in which the oligosaccharides evade from digestion and absorption in the small intestine, and reach the large intestine, where the oligosaccharides are assimilated by enteric bacteria and increase bifidobacteria. Hence, the oligosaccharides can be regarded as having substantially the same functions.

In contrast, dietary fibers exist in a wide variety, and have mutually different characteristics such as the origins, physical properties, constituent sugars, bonding modes, and possibilities and degrees of assimilation by enteric bacteria. For example, it is well known that water-soluble dietary fibers and water-insoluble dietary fibers have physiological functions different from each other. Moreover, even among water-soluble dietary fibers, functions thereof and the strengths of effects thereof are different, and hence water-soluble dietary fibers cannot be discussed collectively. Actually, regarding the promotion of IgA secretion, there are reports on results of comparison among multiple dietary fibers in identical experiments. A published article (Non-Patent Literature 4) states that pectin promoted IgA secretion, but konjak mannan did not, and another published article (Non-Patent Literature 5) states that guar gum, glucomannan, and pectin increased the amount of IgA produced, but a guar gum degradation product did not, although these are dietary fibers sharing a common physical property of water-solubility. Moreover, polydextrose (Non-Patent Literature 6) and NUTRIOSE (Non-Patent Literature 7), which are water-soluble dietary fibers having relatively low-molecular weights and low viscosities are reported to have decreased the amount of IgA secreted. As described above, even among water-soluble dietary fibers, the same results are not obtained regarding the promotion of IgA secretion. Hence, the presence or absence of the action of promoting IgA secretion cannot be predicted based on the similarity in physical properties.

### CITATION LIST

[Patent Literature 1] Japanese Patent Application Publication No. 2003-201239

[Patent Literature 2] Japanese Patent No. 4382465

[Non-Patent Literature 1] Journal of Japanese Society of Nutrition and Food Science, 2008, 61, 79-88.

[Non-Patent Literature 2] Functional Glyco-Materials: Their Development and Application to Foods, CMC Publishing Co., Ltd., 131-132, 2005.

[Non-Patent Literature 3] J. Appl. Glycosci., 2007, 54, 169-172.

[Non-Patent Literature 4] J. Nutr., 1997, 127(5) 663-7.

[Non-Patent Literature 5] Biosci. Biotechnol. Biocem., 2003, 67(2) 429-33.

[Non-Patent Literature 6] British J. Nutr., 2007, 98, 123-33.

[Non-Patent Literature 7] Inflamm. Bowel Dis., 2010, 16(5) 783-94

### SUMMARY OF INVENTION

In this respect, an object of the present invention is to provide a novel IgA secretion promoter useful as a mucosal immunity stimulation agent or to provide a novel method of promoting IgA secretion in an animal to stimulate mucosal immunity.

In order to provide an IgA secretion promoter which can be orally ingested in a safe, continuous, and easy manner, and which is capable of stimulating functions of the mucosal immunity, the present inventors have assayed food ingredients having this action.

Results of experiments in which mice were fed showed that when mice were fed with a feed obtained by blending indigestible dextrin, which is one of the water-soluble dietary fibers, the amount of IgA secreted in the intestinal tract and the amount of IgA in feces increased depending on the dose of the indigestible dextrin. This has revealed that indigestible dextrin is effective as a novel IgA secretion promoter.

Accordingly, it is revealed that indigestible dextrin has an action of stimulating the mucosal immunity.

Indigestible dextrin is also reported to have functions effective against metabolic syndrome, such as blood glucose-lowering action, lipid-lowering action, and body fat-reducing action, and also to exert an influence on intestinal flora because of the property of being assimilated by enteric bacteria. However, there is no report so far regarding an influence on IgA secretion or intestinal immunity. In addition, as described above, NUTRIOSE and polydextrose, which are water-soluble dietary fibers as in the case of indigestible dextrin and which have extremely similar physical properties and functions to those of indigestible dextrin, are reported to have an effect of improving intestinal flora by being assimilated by enteric bacteria, but not to promote IgA secretion. In other words, improvement of intestinal flora does not necessarily result in promotion of the IgA secretion, and the promotion of IgA secretion by indigestible dextrin cannot be predicted from conventional reports. Surprisingly, the inventors have found that indigestible dextrin has an action of promoting IgA secretion, and this finding has led to completion of the present invention.

Specifically, the present invention provides an IgA secretion promoter comprising indigestible dextrin as an active ingredient.

### EFFECT OF THE INVENTION

The IgA secretion promoter in the present invention is a novel IgA secretion promoter comprising indigestible dextrin as an active ingredient, and is safe and can be ingested orally and continuously. Indigestible dextrin is water-soluble and low in viscosity, and does not have sweetness or any characteristic taste. Hence, indigestible dextrin can be used for any foods and pharmaceuticals. In other words, this IgA secretion promoter is so versatile as to be applied widely for foods and beverages, pharmaceuticals, and the like. When the IgA secretion promoter in the present invention is orally ingested, the IgA secretion promoter promotes IgA secretion in the intestinal mucous membrane, and thereby blocks attachment of pathogenic microorganism onto the gastrointestinal mucous membrane, so that infection can be prevented.

### BRIEF DESCRIPTION OF THE DRAWINGS

FIG. 1 shows measurement results of the amounts of IgA in gastrointestinal contents in an experiment in which an effect of promoting IgA secretion achieved by indigestible dextrin was evaluated by using mice.

FIG. 2 shows measurement results of the amounts of IgA in feces in the experiment in which an effect of promoting IgA secretion achieved by indigestible dextrin was evaluated by using mice.

FIG. 3 shows measurement results of the amounts of IgA in cell culture liquids of Peyer's patches obtained from excised small intestine in the experiment in which an effect of promoting IgA secretion achieved by indigestible dextrin was evaluated by using mice.

FIG. 4 shows measurement results of the amounts of IL-12 in cell culture liquids of Peyer's patches obtained from excised small intestine in the experiment in which an effect of promoting IgA secretion achieved by indigestible dextrin was evaluated by using mice.

### DESCRIPTION OF EMBODIMENT

The present invention provides an IgA secretion promoter comprising indigestible dextrin as an active ingredient or a method of promoting IgA secretion in a body of animal by orally administering an IgA secretion promoter comprising indigestible dextrin as an active ingredient to the animal. Specifically, the IgA secretion promoter of the present invention contains, as an active ingredient, indigestible dextrin which is obtained by digesting pyrodextrin with α-amylase and/or glucoamylase and which preferably contains indigestible components in an amount of at least 45% by mass. The indigestible dextrin in the present invention may be hydrogenated products (reduced products) of indigestible dextrin.

In the present invention, the IgA secretion promotion refers to a function of stimulating and activating secretion of IgA, thereby relatively increasing the total amount of IgA in secretion or excrement. For example, the IgA secretion promotion means that when the amount of IgA in secretion or excrement is measured after ingestion of the IgA secretion promoter by a method described in an evaluation test in Examples of this description, the amount of IgA is increased in comparison with a control.

Regarding the method for measuring the amount of IgA secreted, kits such as IgA ELISA Quantitation Kit (COSMO BIO co., ltd.) and Salivary EIA Kit (Funakoshi Co., Ltd.) are commercially available, and the amount of IgA secreted can be measured by using any of these kits. Alternatively, the amount of IgA secreted can be measured by ELISA designed by the inventors, which will be described later.

The pyrodextrin used for producing the indigestible dextrin is dextrin which is a dry-degradation product of starch obtained by heating starch to a temperature in the range from 120 to 200° C. in the presence of an inorganic acid such as hydrochloric acid or an organic acid such as oxalic acid, and which contains a small amount of non-digestible components.

More specifically, the pyrodextrin may be obtained by adding, to starch, a mineral acid (for example, hydrochloric acid, nitric acid, or sulfuric acid), preferably hydrochloric acid, for example, 3 to 10 parts by mass of a 1% by mass aqueous hydrochloric acid solution relative to 100 parts by mass of the starch, followed by a heat treatment. In order to uniformly mix the starch and the aqueous mineral acid solution before the heat treatment, it is preferable that the mixture be stirred, and aged (for several hours) in an appropriate mixer, and then the water content in the mixture be reduced to about 5% by mass by preliminary drying at preferably about 100 to 120° C. It is appropriate to conduct the heat treatment at 120 to 200° C., and preferably 150 to 200° C. for 10 minutes to 120 minutes, and preferably 30 minutes to 120 minutes. The higher the heat treatment temperature, the higher the content of indigestible components in the target product. However, since colored substances tend to be formed at 180° C. or higher, the heat treatment temperature is more preferably 150 to 180° C. The acid used for the degradation of the pyrodextrin with an acid may be an organic acid (for example, oxalic acid or citric acid) or an inorganic acid (for example, hydrochloric acid, nitric acid, or sulfuric acid). The acid is preferably hydrochloric acid, oxalic acid, or the like, and further preferably hydrochloric acid.

A more specific method for producing the indigestible dextrin is as follows. An aqueous solution containing pyrodextrin in an amount of about 20 to 45% by mass is prepared, and the pH of the aqueous pyrodextrin solution is adjusted to 5.5 to 6.5. Then, an α-amylase is added thereto, for example, in an amount of 0.05 to 0.2% by mass to the pyrodextrin in the case of Termamyl 60 L (trade name, manufactured by Novo Nordisk Bioindustries). When other α-amylase is used, it is only necessary to add the α-amylase in an equivalent amount which depends on the potency of the enzyme. After the addition of the α-amylase, the solution is heated to carry out hydrolysis at 85 to 100° C. (the temperature varies depending on the kind of the α-amylase), at which the α-amylase acts, for 30 minutes to 2 hours. Subsequently, the temperature is elevated to about 120° C. (the inactivation temperature of the α-amylase) to stop the action of the α-amylase. At this time, the pH may be lowered to a value at which the α-amylase is inactivated, i.e., about pH 4 by adding an acid such as hydrochloric acid or oxalic acid.

After post treatments such as removal of the low-molecular weight fraction, desalination, and decolorization, the thus obtained hydrolysate of pyrodextrin can be used as the indigestible dextrin in the IgA secretion promoter of the present invention. Preferably, the content of indigestible components is increased by further performing hydrolysis with glucoamylase. Specifically, the temperature of the liquid is lowered to 60° C., and the pH is adjusted to 4 to 5, and preferably 4.5. Hydrolysis is conducted at 55 to 60° C. for 4 to 48 hours by adding glucoamylase in an amount of 0.05 to 0.4% by mass relative to the solid content mass, so that components other than indigestible components are decomposed into glucose. Then, the temperature is elevated to 80° C. to stop the enzymatic action of the glucoamylase. Any commercially available glucoamylase can be used as the glucoamylase, and examples thereof include GLUCZYME NL 4.2 (trade name: Amano Enzyme Inc.), and the like. After that, decolorization with activated carbon, filtration, desalination and decolorization with an ion-exchange resin are performed in a usual manner, and the liquid is concentrated to a concentration of about 50% by weight.

The liquid is passed through a strongly acidic cation exchange resin tower, and separated into indigestible dextrin and a glucose fraction by chromatographic separation technique. Thus, indigestible dextrin can be obtained which contains indigestible components in an amount of at least 45% by mass, preferably 60% by mass or more, and further preferably 85 to 95% by mass relative to the solid content.

The indigestible dextrin may be used after being subjected to a catalytic reduction by being brought into contact with hydrogen gas in the presence of a metal catalyst such as Raney nickel under the conditions of 80 to 120 kg/cm² and 120 to 140° C. Examples of commercially available preparations of indigestible dextrin include Pine Fiber, Fibersol 2, and Fibersol 2H (these are manufactured by Matsutani Chemical Industry Co., Ltd.).

The IgA secretion promoter of the present invention may be the indigestible dextrin or reduced indigestible dextrin itself, or may be used in combination with other compounds having a function of promoting IgA secretion. Examples of the other compounds having a function of promoting IgA secretion include fructooligosaccharide, pectin, galactooligosaccharide, and isomaltooligosaccharide.

In addition, other components such as various kinds of starch, modified starch, starch degradation products, saccharides, sugar alcohols, and soybean polysaccharides may be blended in the IgA secretion promoter of the present invention. Moreover, sweeteners, coloring agents, preservatives, thickening stabilizers, antioxidants, gum bases, spices, bitter flavoring agents, enzymes, brightening agents, acidulants, condiments, emulsifiers, gluten, supplements for nutritional enrichment, and the like can be blended in the IgA secretion promoter of the present invention. The blending ratio should be designed in consideration of the prescribed amount or the added amount at the ingestion of the IgA secretion promoter or the ingestion of a food produced or prepared by blending the IgA secretion promoter, and also in consideration of the subject of the ingestion. For a normal adult, it is preferable to design the blending ratio so that at least 3 g, preferably at least 5 g, and more preferably at least 10 g of the indigestible dextrin, which is the active ingredient, can be ingested per day.

The IgA secretion promoter of the present invention obtained by the above-described method can be prepared in various dosage forms. For example, when the IgA secretion promoter is orally administered as a pharmaceutical, the dosage form can be a tablet, a capsule, a powder, a granule, a pill, a liquid, an emulsion, a suspension, a solution, a spirit, a syrup, an extract, or an elixir, but is not limited thereto. In addition, various pharmaceutically acceptable carriers can be added to the pharmaceutical preparation. For example, the pharmaceutical preparation can contain excipients, binders, disintegrators, lubricants, flavoring agents, coloring agents, sweeteners, corrigents, solubilizers, suspending agents, emulsifiers, and coating agents, but the carriers are not limited thereto. The IgA secretion promoter of the present invention may be prepared as a persistent preparation or a sustained-release preparation.

How to ingest the IgA secretion promoter of the present invention is not particularly limited, and for example, the IgA secretion promoter of the present invention is preferably orally ingested in the form of an aqueous solution, a tablet, a granule, or the like.

Moreover, the IgA secretion promoter of the present invention can be ingested, after blended in foods and beverages to which modified starch is known to be applicable. For example, the IgA secretion promoter of the present invention may be blended in bakery foods, noodles, OKONOMIYAKI (Japanese savory pancake), TAKOYAKI (a ball-shaped Japanese snack), snack foods such as pancakes, Japanese confectionery products, paste foods, batter for fried foods, fritters, yogurts, crème caramel, jellies, dressings including mayonnaises and Worcestershire sauces, thick starchy sauces, frozen desserts such as ice creams, animal meat products, rice food products, imitation rice, various beverages such as powder beverages, refreshing beverages, carbonated beverages, soft yogurts, and jelly beverages, and the like. Preferably, the IgA secretion promoter of the present invention is blended in bakery products, noodles, and jelly beverages.

Meanwhile, in the use as a feed, the IgA secretion promoter of the present invention may be administered as it is, or after blended in a known feed for livestock or a known feed for a companion animal. Moreover, it is also possible to supply the IgA secretion promoter of the present invention in the form of a premix.

The IgA secretion promoter of the present invention can be used also as an agent for stimulating mucosal immunity functions, an agent for preventing infectious diseases, and an anti-allergic agent.

Hereinafter, effects of the IgA secretion promoter of the present invention are described by way of examples. However, the present invention is not limited to these examples.

### EXAMPLES

Six-week old female BALB/c mice were preliminary fed for one week with a solid feed, and then divided into three groups, which were then fed with a control feed, a feed obtained by blending 5% by mass of indigestible dextrin (trade name: Fibersol 2) with the control feed, and a feed obtained by blending 7.5% by mass of the indigestible dextrin with the control feed, respectively. During the feeding, the mice were allowed to ingest the feed and water ad libitum. Feces were collected for 24 hours from 8 a.m. to 8 a.m. on the next morning three times, i.e., 1, 2, and 4 weeks after the start of the test. After that, the gastrointestinal contents were collected by dissection. IgA in the obtained feces and the obtained gastrointestinal contents was measured by a sandwich ELISA method shown below.

### Quantification of Total IgA by ELISA

A goat anti-mouse IgG F(ab′)₂ antibody (SIGMA) diluted to 10 μg/ml with 0.1 M sodium dihydrogen phosphate (pH 9.0) was added to a 96-well microtiter plate (Nunc) at 50 μl/well, and the antibody was adsorbed on the plate by incubation at 4° C. overnight. The wells were washed three times with 0.05% Tween-20-containing phosphate buffered saline (PBST), and then 100 μl of 1% BSA-PBS was added thereto. Blocking was performed by incubation at room temperature for 2 hours. After the wells were washed three times with PBST, a culture supernatant of Peyer's patch (PP) cells cultured for 7 days obtained by centrifugation at 4° C. and 300G for 10 minutes was diluted to 1/50 with 1% BSA-PBST, and 50 μl of the diluted culture supernatant was added to each well. Similarly, extraction liquids of the intestinal contents were diluted to 1/2000, and 50 μl of the diluted extraction liquids were added. Standard solutions were prepared by diluting a purified mouse myeloma IgA antibody (Kappa) (Bethyl Laboratories, Montgomery, Tex.) to 200 ng/ml with 1% BSA-PBST, followed by two-fold serial dilution. To the wells, 50 μl of these standard solutions were added, and used as standard solutions for creating a standard curve. After the wells were washed four times with PBST, 50 μl of an alkaline phosphatase-labeled goat anti-mouse IgA (a chain specific) antibody (Southern Biotech, Birmingham, Ala.) diluted to 1/2000 with 1% BSA-PBST was added, followed by incubation at room temperature for 2 hours. After the wells were washed eight times with PBST, disodium 4-nitrophenyl phosphate (Tokyo Chemical Industry Co., Ltd., Tokyo) was dissolved in a diethanolamine buffer solution at a concentration of 1 mg/ml, and 50 μl of the solution was added to each well. The plate, which was protected from light, was incubated at 37° C. for 20 to 30 minutes, and then the absorbance at 405 nm was measured with Microplate Reader Model 550 (Bio-Rad Laboratories, Alfred Nobel Drive Hercules, Calif.). The analysis was carried out by using Micro Plate Manager III (Bio-Rad Laboratories).

In addition, two-week after the start of the test, small intestine Peyer's patches were excised from mice of each group at the dissection, and the cells were dispersed by using an enzyme. Thus, cell suspensions were prepared. Each cell suspension whose viable cell concentration was adjusted to 8×10⁶ cells/mL by counting the number of viable cells under a microscope and trypan blue staining was dispensed to the culture plate at 500 μL/well, and the cells were cultured in a CO₂ incubator. To evaluate whether or not continuous ingestion of indigestible dextrin had a potential for IgA secretion by Peyer's patches, the cells were cultured in the same manner under conditions that an equivalent amount of lipopolysaccharide (LPS) or concanavalin A (conA) was added as a stimulant to the culture medium of each group. Then, IgA in each culture liquid and, as an index of the IgA secretion performance, interleukin-12 (IL-12) therein were measured. The IL-12 was measured by a sandwich ELISA method shown below.

### Measurement of IL-12 by ELISA

A rat anti-mouse IL-12 (p40/p70) antibody (BD pharmigen, San Diego, Calif., USA) diluted with 0.1 M sodium dihydrogen phosphate (pH 9.0) to 2 μg/ml was added to a 96-well microtiter plate (Nunc) at 50 μl/well, and the antibody was adsorbed on the plate by incubation at 4° C. overnight. The wells were washed three times with PBST, and then 100 μl of 1% BSA-PBS was added thereto. Blocking was performed by incubation at room temperature for 2 hours. After the wells were washed three times with PBST, 50 μl of a culture supernatant of PP cells cultured for 24 hours obtained by centrifugation at 4° C. and 300G for 10 minutes was added to each well. Standard samples were obtained by diluting recombinant mouse IL-12 p40 (BD Pharmigen™, San Diego, Calif., USA) with 1% BSA-PBST to 4000 pg/ml, followed by two-fold serial dilution. To the wells, 50 μl of these standard samples were added, and used as standard solutions for creating a standard curve. After the wells were washed four times with PBST, 50 μl of a biotin-labeled rat anti-mouse IL-12 (p40/p70) antibody (BD Pharmigen™, San Diego, Calif., USA) diluted with 1% BSA-PBST to 2 μg/ml was added to each well, followed by incubation at room temperature for 2 hours. After the wells were washed six times with PBST, 50 μl of an alkaline phosphatase-labeled streptavidin (Zymed, San Francisco, Calif.) diluted with 1% BSA-PBST to 0.6 μg/ml was added to each well, followed by incubation at room temperature for 2 hours. After the wells were washed six times with PBST, disodium 4-nitrophenyl phosphate (Tokyo Chemical Industry Co., Ltd., Tokyo) was dissolved in a diethanolamine buffer solution at a concentration of 1 mg/ml, and 50 μl of the solution was added to each well. The plate, which was protected from light, was incubated at 37° C. for approximately 120 minutes, and then the absorbance at 405 nm was measured with Microplate Reader Model 550 (Bio-Rad Laboratories, Alfred Nobel Drive Hercules, Calif.). The analysis was carried out by using Micro Plate Manager III (Bio-Rad Laboratories).

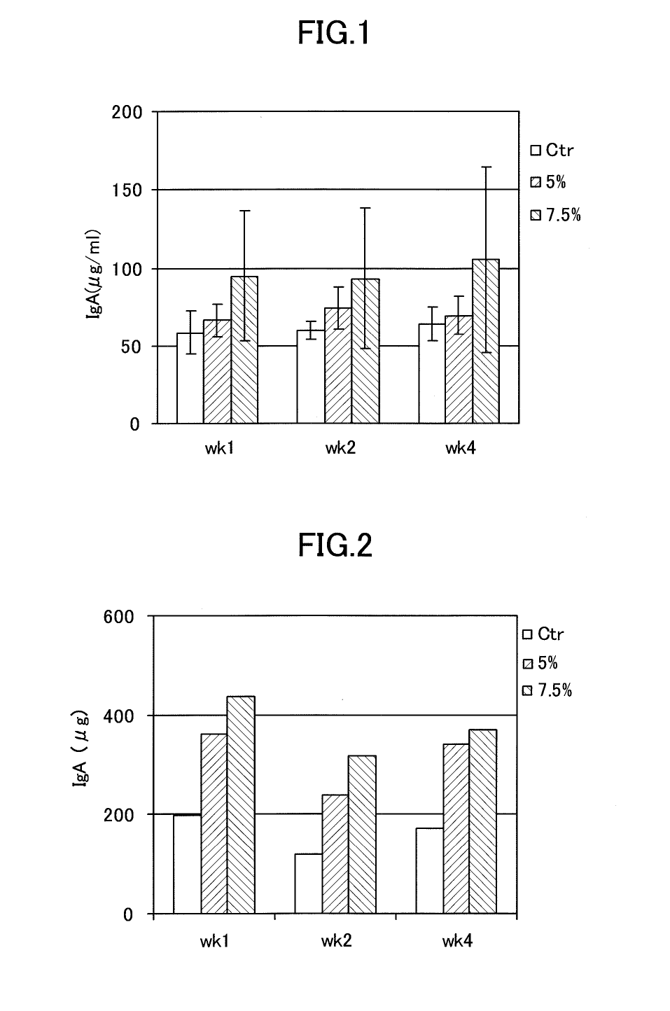

As a result, the amount of IgA in the gastrointestinal contents increased depending on the dose of the indigestible dextrin blended in the feed (FIG. 1). Likewise, the amount of IgA in the feces also increased depending on the dose of the indigestible dextrin (FIG. 2).

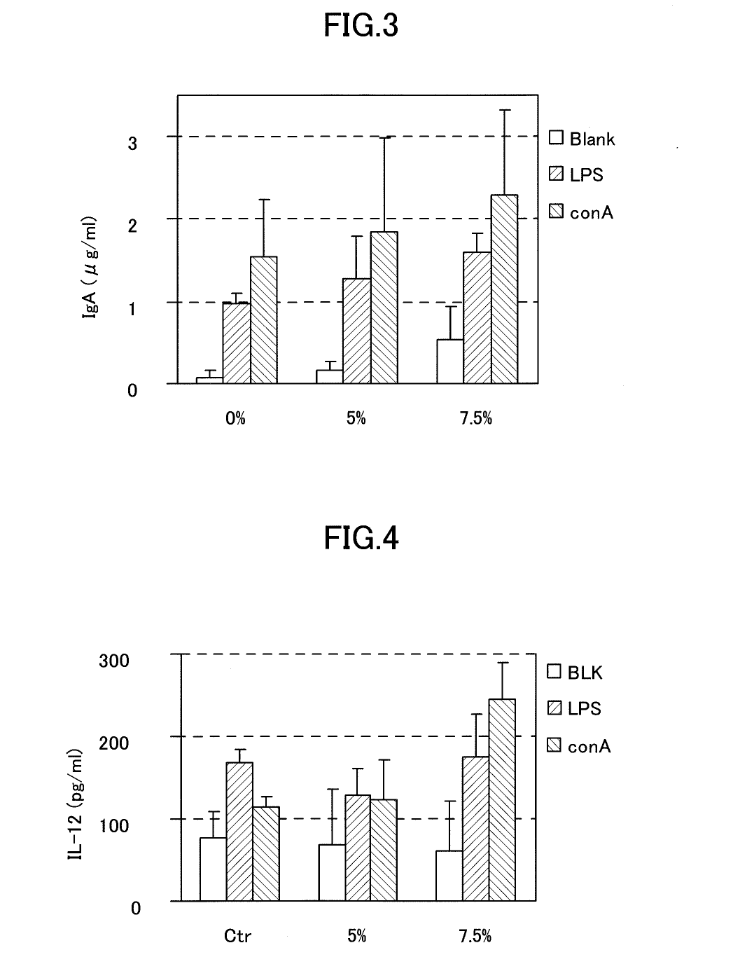

When LPS or conA was added, the IgA in the cell culture liquid increased in the indigestible dextrin ingestion groups. This has revealed that indigestible dextrin promotes the IgA production ability of Peyer's patches (FIG. 3).

Regarding IL-12, when each of the secretion activation agents was added, the amount of IL-12 increased in the indigestible dextrin ingestion groups (FIG. 4). IL-12 is a cytokine characterized by a remarkable action of activating NK cells. IL-12 is produced by B cells and monocytic cells, and exhibits actions such as promotion of growth of T cells and NK cells, cytotoxicity induction, IFN-γ production induction, and LAK cell induction. Because of such roles in cell-mediated immunity functions, IL-12 is expected to be clinically applied for protection from infection and for amelioration of immunodeficiency. For example, IL-12 production, IFN-γ production, and NK cell activity are all significantly lowered in peripheral blood lymphocytes of HIV-infected patients. It is known that administration of IL-12 increases these productions and activity to the same levels as those of healthy individuals. Hence, the increases in IgA secretion ability and IL-12 production ability by ingestion of indigestible dextrin indicates that indigestible dextrin stimulates the mucosal immunity.

From the above results, it has been shown that indigestible dextrin is useful as an IgA secretion promoter, and has an action of stimulating the mucosal immunity.

1. An IgA secretion promoter comprising indigestible dextrin as an active ingredient.

2. The IgA secretion promoter according to claim 1, wherein the indigestible dextrin contains indigestible components in an amount of 45% by mass or more.

3. The IgA secretion promoter according to claim 1, wherein the IgA secretion promoter is prepared in a dosage form for oral administration.

4. The IgA secretion promoter according to claim 1, wherein the indigestible dextrin is prepared by treating pyrodextrin with α-amylase and/or glucoamylase.

5. The IgA secretion promoter according to claim 4, wherein the pyrodextrin is obtained by heating starch to a temperature in the range from 120 to 200° C. in the presence of an inorganic acid.

6. A mucosal immunity stimulation agent, an anti-infective agent, or an anti-allergic agent, comprising the IgA secretion promoter according to claim 1.

7. A method of promoting IgA secretion in a body of animal by comprising orally administering the an IgA secretion promoter of claim lcomprising indigestible dextrin as an active ingredient to the animal.

8. The method according to claim 7, wherein the indigestible dextrin contains indigestible components in an amount of 45% by mass or more.

9. The method according to claim 7, wherein the indigestible dextrin is prepared by treating pyrodextrin with α-amylase and/or glucoamylase.

10. The method according to claim 9, wherein the pyrodextrin is obtained by heating starch to a temperature in the range from 120 to 200° C. in the presence of an inorganic acid.

11. The method according to claim 7, which stimulates mucosal immunity of the animal.
